(19) United States
(12) Patent Application Publication
(10) Pub. No.: US 2004/0077409 A1
(43) Pub. Date: Apr. 22, 2004

(54) Effective, low-cost torque limiting drive

(76) Inventors: Michael David Lattuca, Lexington, KY (US); Daniel George Mlejnek, Nicholasville, KY (US); Richard Andrew Seman JR., Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/272,770

(22) Filed: Oct. 17, 2002

(51) Int. Cl. F16D 7/04

(52) U.S. Cl. 464/37

(57) ABSTRACT

A drive linkage has internal shaft (1) having a bump (3) and an external shaft (11) having an open center and a bump (15) extending into the opening. The bumps are aligned and meet at surfaces having an angle with an outward component and a lateral component. In normal operation shaft (11) is rotated by the lateral component of force from bump (3). If the driven element will not move, then the outward component of force from bump (3) forces shaft (11) outward to allow bump (3) to move past bump (15). (Alternatively shaft 11 or both shaft 11 and shaft 1 may flex.) This prevents damage to the drive linkage or at an element being driven. The drive linkage is undamaged and simply continues to attempt to drive as described. The two shafts with bumps each may be inexpensively molded as one piece.

### TECHNICAL FIELD

This invention relates to drive link between and motor or other drive source and a mechanism being driven, such as a wheel. The mechanism of this invention has a torque limiting connection to prevent damage when the driven mechanism does not move, as can occur when the driven mechanism is overloaded.

### BACKGROUND OF THE INVENTION

In assemblies in which a motor drives a single element, the motor can be powered to simply stall when the element will not move. No damage to the motor or drive linkage need result. However, where the motor drives more than one element, such as a single motor in a printer driving the photoconductor, the fixing belt or roller, the paper pick roller or rollers, and several other rollers, the motor can not be so low powered to simply stall if the paper pick roller, for example is blocked. Another purpose for torque limiting drives is to limit the output power to prevent damage to an object being worked on, such as to prevent a screwdriver from overdriving a screw.

In a printer or the like the paper pick roller is prone to be blocked or jammed. At times paper in a feed tray sticks together and moves as a pack. This typically results in the pick roller not moving even under high power from the driver. Structural damage results, such as the stripping of a gear in the drive linkage. Where the pick roller in cross section is formed as a partial circle with a flat segment facing a stack of papers to be fed (termed a D roller), overloading the stack can block the D roller.

To prevent structural damage, a drive which yields at high torque without damage to the drive is desirable. Such torque limiting drives in devices such as screwdrivers are believed to be known, but none is known which is low cost and reliable in operation such as that of this invention.

### DISCLOSURE OF THE INVENTION

In this invention a motor is linked to a driven element, such as a pick roller, through a central shaft having a raised portion or bump which is inserted in a surrounding shaft having a raised portion or bump. The two shafts have diameters such that the two bumps will encounter each other at one angular position of the two shafts. Preferably the two bumps are dome-like or generally semi-circular in cross section when viewed down the shafts and elongated when viewed from the side of the shaft. Preferably also, the bumps are of height to substantially fill the radial distance between the two shafts.

Where the driven shaft is attempting to drive a blocked element, the driving bump has a sufficient outward angle to cause the outer shaft, the driven shaft, or both to flex, at which time the outward angle increases and the driving bump moves past the bump. After a full revolution, the two bumps encounter each other again, but the yielding as described will again occur if the driven element still does not respond.

In one embodiment the two bumps meet at surfaces at an angle roughly 30 degrees to a line perpendicular to a line from the center of the shafts through the center of either bump. This angle is not critical so long as the abutment of the two bumps is sufficiently canted so that 1) in normal operation the bump on the driving shaft pushes the bump on the driven shaft reliably and consistently without slippage and 2) in blocked operation the driving bump flexes the bump on the driven shaft outward. The device is undamaged and continues to operate as described.

This torque limiting assembly is very low cost since each of the two shafts with integral bumps can be molded in a single operation.

### BRIEF DESCRIPTION OF THE DRAWINGS

The details of this invention will be described in connection with the accompanying drawings in which

FIG. 1 illustrates a solid, internal shaft with elongated bump.

FIG. 2 illustrates a hollow, external shaft with inwardly depending bump.

FIG. 3 is a sectioned, partial end view showing the shafts as combined with the two bumps just beginning to make contact.

FIG. 4 is a sectioned, partial side view showing the two bumps as they are about to pass one another because the driven element is stalled.

FIG. 5 is a graph from observations of an embodiment showing that the torque is reduced even well before the two bumps separate. And,

FIG. 6 illustrates an alternative in which the driven shaft or both shafts are flexible.

### DESCRIPTION OF PREFERRED EMBODIMENTS

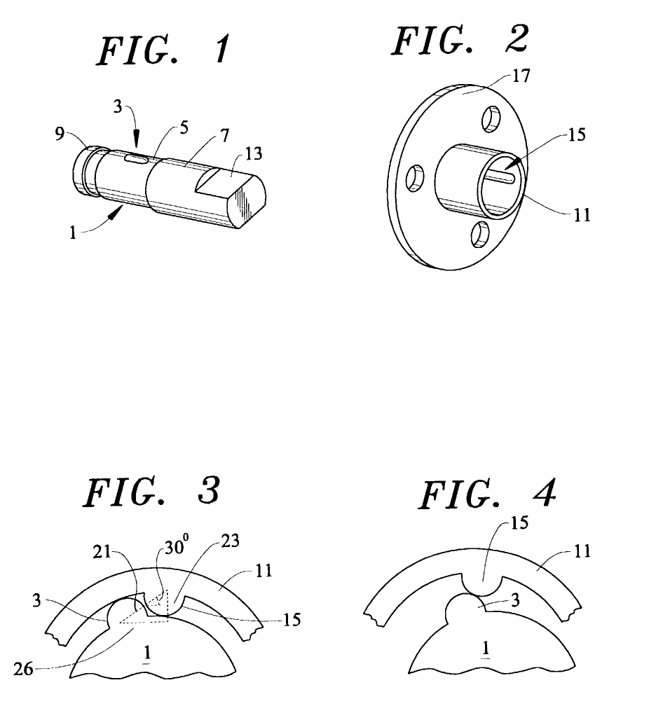

Referring to FIG. 1, a driving, internal shaft 1 has an elongated external bump 3 on internal shaft body 5. Circular, raised surfaces 7 and 9, on opposite sides of body 5 are bearing members of shaft 11 (FIG. 2). Flat 13 is merely illustrative of a surface with which to connect shaft 1 to be driven by a motor (not shown).

In an embodiment the entire shaft 1 as shown is a single element of glass filled polycarbonate resin made in one molding operation.

Referring to FIG. 2, driven shaft 11 has an elongated, generally round, central opening formed by the interior surface of shaft 11. The interior surface of shaft 11 has an elongated, depending bump 15. The internal radius of the opening of shaft 11 is the same as or slightly larger than the radius of shaft 1 from center to the outer surface of bump 3. Accordingly, when shaft 1 is placed in the hollow of shaft 11 in accordance with this invention, upon rotation of shaft 1 the bumps 3 and 15 meet at their surfaces. The disc 17 is merely illustrative of a structure to connect shaft 11 to an element to be driven from shaft 11.

In an embodiment in which shaft 1 is filled polycarbonate as discussed in the foregoing, the entire shaft 11 as shown is a single element of acetal resin made in one molding operation.

More specifically, such an embodiment consistent with FIGS. 1 through 3, internal shaft body may be about 5.25 mm in diameter, raised surfaces 7 and 9 would then be about 5.95 mm and about 5.25 mm, respectively, in diameter. The circular cross section of bumps 3 and 15 would be about 0.5 mm in radius. The internal diameter of shaft 11 not including bump 5 would be about 6.05 mm. The length of bumps 3 and 15 would be about 3 mm and 5.5 mm, respectively, when the two shafts 1 and 11 are assembled in accordance with this invention the lengths of the two bumps 3 and 15 coincide.

FIG. 3 is a sectioned end view showing bumps 3 and 15 when just beginning to make contact. Internal shaft 1 is the driving member, and shaft 11 is the driven member. The driving connection is only bump 3 pushing bump 6.

In this embodiment bumps 3 and 15 are the same radius and the radial distance between the outer end of bump 3 and the inner surface of shaft 11 is minimal. Similarly, the radial distance between the outer end of bump 15 and the outer surface of shaft 1 is minimal. Ignoring the curvature of shafts 1 and 11, by symmetry an imaginary line 21 (shown dotted) from the center of each bump 3 and 15 to the other bump 3 and 15 is the length of twice the radius of bumps 3 or 15, and line 21 passes through the point of contact of bumps 3 and 15. An imaginary line 23 (shown dotted) from the center of bump 15 to the top of bump 15 is a length on one radius of bumps 3 or 15.

Accordingly, a right triangle is found with lines 21 and 23 and imaginary line 26 (shown dotted) between the center of bump 3 and the top of bump 15. This defines the 30, 60, 90 degree triangle with line 26 being the square root of three times the radius of bumps 3 or 15 approximately 1.73 times the radius, and with the 30 degree angle being at bump 3.

By symmetry bumps 3 and 15 are known to meet as tangents. The same 30 degree angle exists to define the vector forces of the tangential meeting of bumps 3 and 15. This establishes that the force at initial contact of bumps 3 and 15 is generally in a ratio of 1 part outward toward bending shaft 11 outward and 1.73 parts lateral toward rotating shaft 11.

When shaft 11 is not blocked, its rotation prevents bump 3 from forcing shaft 11 outward enough for bump 3 to pass bump 15. When shaft 11 does not move, shaft 11 deforms to permit bump 3 to pass. FIG. 4 illustrates bump 3 forcing bump 15 upward. It is apparent that as bump 15 moves outward the foregoing angle that was 30 degrees at meeting of bumps 3 and 15, increases thereby increasing the amount of force which is in the outward direction.

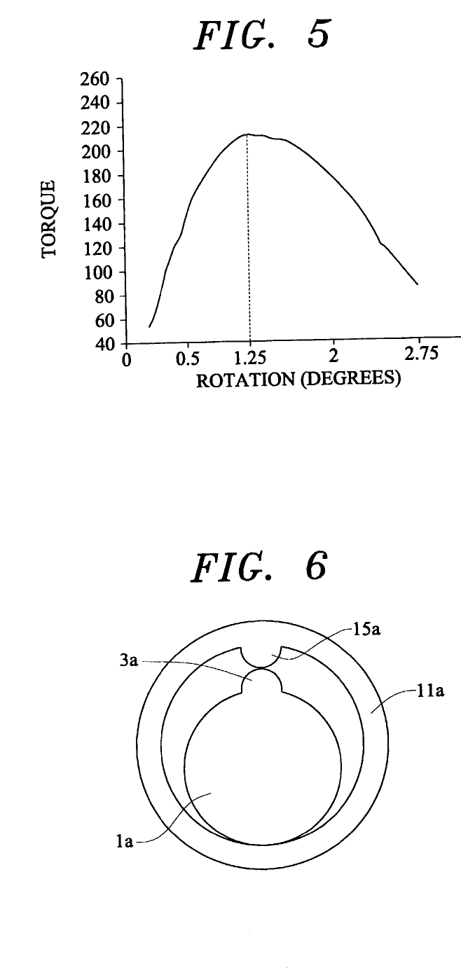

FIG. 5 illustrates the quick reduction in lateral force after reaching the highest lateral force more slowly. In FIG. 5 the horizontal axis is angle of rotation of the driven shaft 1 and the vertical axis is the torque developed from the interference of bumps 3 and 15. As discussed and shown in FIG. 5, the maximum torque occurs before the bumps 2 and 15 are on top of one another.

After bump 3 moves past bump 15 this device is undamaged and continues to operate repetitively as described. Typically, any drive will be terminated and the source of blockage of shaft 11 corrected after which the device will move shaft 11 as described.

The device as disclosed should be subjected to several (at least 6, preferably many more) controlled failure operations, as this conditions the surfaces of bumps 3 and 15 to operate consistently (which may be termed a wear-in period).

### Flexible Drive Shaft

In the foregoing embodiments, the shaft 1 is substantially inflexible with respect to operation as described. As alternatives to the foregoing description, both the center drive shaft may be chosen to flex and both may be chosen to flex. This is illustrated in FIG. 6 in which the center shaft 1a is shown flexed by the two bumps as described. Bumps 3a and 11a are shown passing each other. Outer shaft 11a may also flex somewhat. Functionality is essentially as described in the foregoing. Depending on the length of shaft 1a, suitable flexing may be readily achieved with a variety of materials for shaft 1.

### Roll of Friction and Velocity

For the two bumps as described to move past one another, their mutual friction must be overcome. Accordingly, friction may be a limiting factor and particularly high friction should be avoided in most designs. A factor which reduces friction is velocity. Accordingly, as the driven shaft operates at high velocities, the effects of friction are reduced.

Although the foregoing generally symmetrical embodiments with round-in-cross-section bumps has been found to function well, it will be apparent that the interaction of lateral and outward forces can be achieved with a wide latitude of shapes and differences in the resistance to yield of the material forming the shaft 11 or other element or elements intended to yield under sufficient force.

What is claimed is:

1. A torque limiting drive comprising
a first, generally round shaft have a longitudinal outer surface,
a first raised portion on said outer surface of said first shaft,
a second shaft having a longitudinal, generally round interior opening, said second shaft having an interior surface forming said opening,
a second raised portion on said interior surface of said second shaft,
said first shaft being located in said opening of said second shaft with said first raised portion and said second raised portion meeting at an angular rotation of said first shaft with respect to said second shaft, and
at least one of said first shaft and said second shaft being flexible to allow said raised portions to flex said at least one flexible shaft and move apart when a high level of torque is applied to one of said first shaft and said second shaft, while permitting one of said first shaft and said second shaft to drive in rotation the other of said first shaft and said second shaft at levels of torque lower than said high level of torque.

2. The torque limiting drive as in claim 1 in which said first shaft drives said second shaft by contact of said first raised portion against said second raised portion.

3. The torque limiting drive as in claim 1 in which said first raised portion and said second raised portion are each generally semi-circular in cross section when viewed down the longitudinal length of said shafts and are generally elongated when view from the side of said shaft.

4. The torque limiting drive as in claim 2 which said first raised portion and said 5, second raised portion are each generally semi-circular in cross section when viewed down the longitudinal length of said shafts and are generally elongated when view from the side of said shaft.

5. The torque limiting drive as in claim 1 in which said semi-circular cross sections of said raised portions are of substantially the same size and said raised portions occupy all of the radial distance between said outer surface of said first shaft and said inner surface of said second shaft.

6 The torque limiting drive as in claim 2 in which said semi-circular cross sections of said raised portions are of substantially the same size and said raised portions occupy all of the radial distance between said outer surface of said first shaft and said inner surface of said second shaft.

7. The torque limiting drive as in claim 3 in which said semi-circular cross sections of said raised portions are of substantially the same size and said raised portions occupy all of the radial distance between said outer surface of said first shaft and said inner surface of said second shaft.

8. The torque limiting drive as in claim 4 in which said semi-circular cross sections of said raised portions are of substantially the same size and said raised portions occupy all of the radial distance between said outer surface of said first shaft and said inner surface of said second shaft.

9. The torque limiting device as in claim 1 in which each said first shaft and said first raised portion are integral and said second shaft and said second raised portion are integral.

10. The torque limiting device as in claim 2 in which said first shaft and said first raised portion are integral and said second shaft and said second raised portion are integral.

11. The torque limiting device as in claim 3 in which said first shaft and said first raised portion are integral and said second shaft and said second raised portion are integral.

12. The torque limiting device as in claim 4 in which said first shaft and said first raised portion are integral and said second shaft and said second raised portion are integral.

13. The torque limiting device as in claim 5 in which said first shaft and said first raised portion are integral and said second shaft and said second raised portion are integral.

14. The torque limiting device as in claim 6 in which said first shaft and said first raised portion are integral and said second shaft and said second raised portion are integral.

15. The torque limiting device as in claim 7 in which said first shaft and said first raised portion are integral and said second shaft and said second raised portion are integral.

16. The torque limiting device as in claim 8 in which each said first shaft and said first raised portion is integral and said second shaft and said second raised portion are integral.

17. The torque limiting device as in claim 1 in which said second shaft is outwardly flexible and said first shaft is substantially inflexible.

18. The torque limiting device as in claim 2 in which said second shaft is outwardly flexible and said first shaft is substantially inflexible.

19. The torque limiting device as in claim 3 in which said second shaft is outwardly flexible and said first shaft is substantially inflexible.

20. The torque limiting device as in claim 4 in which said second shaft is outwardly flexible and said first shaft is substantially inflexible.

21. The torque limiting device as in claim 5 in which said second shaft is outwardly flexible and said first shaft is substantially inflexible.

22. The torque limiting device as in claim 6 in which said second shaft is outwardly flexible and said first shaft is substantially inflexible.

23. The torque limiting device as in claim 7 in which said second shaft is outwardly flexible and said first shaft is substantially inflexible.

24. The torque limiting device as in claim 8 in which said second shaft is outwardly flexible and said first shaft is substantially inflexible.

25. The torque limiting device as in claim 9 in which said second shaft is outwardly flexible and said first shaft is substantially inflexible.

26. The torque limiting device as in claim 10 in which said second shaft is outwardly flexible and said first shaft is substantially inflexible.

27. The torque limiting device as in claim 11 in which said second shaft is outwardly flexible and said first shaft is substantially inflexible.

28. The torque limiting device as in claim 12 in which said second shaft is outwardly flexible and said first shaft is substantially inflexible.

29. The torque limiting device as in claim 13 in which said second shaft is outwardly flexible and said first shaft is substantially inflexible.

30. The torque limiting device as in claim 14 in which said second shaft is outwardly flexible and said first shaft is substantially inflexible.

31. The torque limiting device as in claim 15 in which said second shaft is outwardly flexible and said first shaft is substantially inflexible.

32. The torque limiting device as in claim 16 in which said second shaft is outwardly flexible and said first shaft is substantially inflexible.
